(19) United States
(12) Patent Application Publication
(10) Pub. No.: US 2003/0025228 A1
(43) Pub. Date: Feb. 6, 2003

(54) Method for surface polishing of an optical article using a solvent or a mixture of solvents

(75) Inventors: Aude Prieur-Blanc, Lille (FR); Jean-Paul Cano, Chennevieres Sur Marne (FR)

Correspondence Address: Mark B. Wilson, Fulbright & Jaworski L.L.P., Suite 2400, 600 Congress Avenue, Austin, TX, 78701, US

(73) Assignee: Essilor International Compagnie Generale d'Optique, Charenton Cedex (FR)

(21) Appl. No.: 10/068,232

(22) Filed: Feb. 6, 2002

Related U.S. Application Data
(63) Continuation of application No. PCT/FR00/02224, filed on Aug. 2, 2000.

(30) Foreign Application Priority Data
Aug. 6, 1999 (FR) 99/10230

(51) Int. Cl. B29D 11/00

(52) U.S. Cl. 264/2.6; 264/2.7; 264/2.1

(57) ABSTRACT

The invention concerns a method comprising the steps of grinding, fine grinding, and polishing a surface of an optical article made of transparent thermoplastic material, one of the steps of fine grinding or polishing consisting of treating the surface with a solvent or a mixture of solvents. The invention is applicable to lenses for spectacles.

The present invention relates in general terms to a method for surface polishing of the surface of an optical article made from a transparent thermoplastic material.

The main surfaces of an optical article are conventionally subjected to surface polishing.

The surface polishing of an optical article comprises a group of operations leading to the production of an optical article, such as a lens whose surfaces are perfectly polished and have the desired curvatures (optical powers).

Surface polishing typically comprises three successive steps: grinding, fine grinding, and polishing.

Grinding is a mechanical processing step using a coarse-grain diamond cutter or an insert cutter, intended to create the curvature on the surface of the optical article such as a lens or contact lens.

Fine grinding is also a mechanical processing step, performed after the grinding, using a fine-grain diamond cutter or emery (or paper or carborundum). The surface of the optical article after this fine grinding has a matt appearance.

The final operation of the surface polishing, which leads to a perfectly polished and transparent surface, is called polishing and again consists of a mechanical treatment using felt discs in contact with a fine abrasive suspension.

The grinding, which as stated above has the principal object of conferring the desired curvature to at least one surface of the optical article such as a lens or a contact lens, is a step of short duration which leads to an opaque optical article whose ground surface shows waves, defects of large amplitude and low frequency, generally in the form of a spiral pattern, onto which are superimposed a roughness consisting of defects of small amplitude and high frequency.

The fine grinding further changes the geometry of the treated surface of the optical article but is essentially intended to remove the waves as far as possible.

This mechanical treatment step leads to a translucid (but not yet transparent) article whose polished surface still shows significant roughness.

Finally, the polishing, a relatively long mechanical processing step, which does not change the geometry of the treated surface of the article, removes the remaining roughness as far as possible to give the final transparent optical article.

Although a purely mechanical surface polishing such as that described above does enable the production of acceptable optical articles, either from inorganic or organic glass, it has several disadvantages.

Firstly, it is a long process, due in particular to the polishing step. Practice has also shown that it is difficult to remove the waves of large amplitude and low frequency. Finally, the mechanical fine grinding and polishing steps are steps which require a substantial range of equipment and are thus relatively costly.

The French patent no 2 439 072 discloses a method for polishing surfaces of plastic materials, such as polycarbonate, by spraying a solvent vapour onto the surface to be polished.

The U.S. Pat. No. 3,933,518 discloses a method for refluidifying the surfaces of thermoplastic materials by treatment with solvent vapours in order to remove imperfections.

The U.S. Pat. No. 4,376,751 discloses a method for producing a smooth surface on a thermoplastic article which consists of immersing the article in a bath containing at least one solvent of the thermoplastic material and a non-solvent of the thermoplastic material.

The object of the present invention is thus a method for surface polishing of one surface of an optical article made from thermoplastic material which is simple to use, rapid, and enables at least the surface roughness to be removed without deforming the geometry of the treated surface of the optical article.

We have now found that it is possible to surface polish an optical article made from transparent thermoplastic material by replacing one of the mechanical steps of fine grinding or polishing by a fine grinding and/or polishing step by attack using a solvent or a mixture of solvents.

According to the invention, the method of surface polishing of at least one principal surface of an optical article made from transparent thermoplastic material comprises a grinding step, a fine grinding step and a polishing step and is characterized by the fact that the fine grinding and/or polishing step consists of performing an attack on the surface by a solvent or a mixture of organic solvents of the transparent thermoplastic material of the optical article.

The attack step is preferably the polishing step of the surface polishing method, in other words the step of removal of the roughness of the surface of the article.

After grinding, the roughness of the surface of the article is generally characterized by a mean deviation of the roughness profile from the mean line, Ra, of 0.1 to 0.9 μm, typically of 0.2 to 0.5 μm. The polishing step by attack according to the invention enables the Ra value to be reduced by a factor of 5 or more.

The attack step of the surface polishing method according to the invention may be implemented in several ways.

In a first embodiment, the attack on the surface of the article may be performed by placing the surface of the article in contact with the vapour phase of a solvent or mixture of solvents of the thermoplastic material of the article. The vapour phase of the solvent or mixture of solvents may be obtained by heating the solvent and be itself at a temperature greater than the ambient temperature, or without heating, by saturation in the vapour of the solvent or mixture of solvents, the vapour phase being thus at ambient temperature.

For this step of attack with a solvent or mixture of solvents in the vapour phase, with heating, it is recommended to use a relatively short treatment time, generally of 5 minutes or less, so as to avoid deforming the treated surface of the article.

During this attack by hot vapour, the optical article itself may be heated to a temperature higher than ambient temperature, but generally to less than the boiling point of the solvent or mixture of solvents. This thus avoids too great a condensation of the vapour on the surface during the attack.

In general, whatever the mode of attack, the attack must be relatively short and generally of 5 minutes or less. It has been observed, particularly for a polycarbonate article, that prolonged attack results in a tendency for the roughness to increase again.

However, the attack with a solvent or mixture of solvents in the vapour phase, at ambient temperature, such as saturation with solvent vapour, can withstand longer treatment times.

In a second embodiment of the attack step, the thermoplastic optical article is dipped in the solvent or mixture of solvents in the liquid state.

In a third, preferred embodiment of the attack step according to the invention, the contact of the solvent or mixture of solvents with the surface of the article is effected by centrifugation, for example by placing an appropriate quantity of the solvent or mixture of solvents on the surface of a rotating optical article by means of an appropriate device. This embodiment of the method of the invention has the advantages of being rapid (several tens of seconds and generally of the order of 10 seconds), simple and allows the treatment to be automated.

In this centrifugal attack mode, the solvent or mixture of solvents may initially be deposited on the centre of the surface of the article to be treated in order to be spread over the whole surface by centrifugation. However, the solvent or mixture of solvents is preferably deposited radially with respect to the surface of the article to be treated while the article is rotated by the centrifugation device.

More precisely, the radial deposit consists, while the article is in rotation, in depositing the solvent or mixture of solvents along a radius with respect to the rotation axis.

Although this radial deposit of the solvent or mixture of solvents may be effected either from the centre or from the edge of the article, the radial deposit from the centre towards the edge is preferred for better uniformity of the attack.

It is obviously possible to combine the different embodiments of the attack step of the method of the invention. A step of attack by centrifugation may in particular be combined with an attack in the vapour phase. In this case, it is preferable to perform a first attack in the vapour phase, then follow it with an attack by centrifugation.

The method of surface polishing of the invention may be applied to any ophthalmic article in transparent thermoplastic material conventionally used in the field concerned.

These thermoplastic materials include the polycarbonates, the poly(meth)acrylates, the polythio(meth)acrylates and their mixtures. The preferred thermoplastic materials are the polycarbonates, for example bisphenol A polycarbonate.

The solvent or mixture of solvents suitable for the method of the invention may be any solvent or mixture of solvents of the thermoplastic material to be treated.

The preferred solvents, in particular for the polycarbonate optical articles, include dichloromethane (CH₂Cl₂), trichloromethane (CHCl₃), the dichloroethanes such as 1,2-dichloroethane, acetone methyl ethyl ketone, tetrahydrofuran (THF), dioxane and their mixtures.

The solvent or mixture of solvents of the thermoplastic material to be treated may contain, in limited proportion, up to 20% by weight, preferably up to 15% by weight of an organic diluent which is not a solvent of the thermoplastic material to be treated. An example of such an organic diluent is ethylene glycol diacetate.

In the attack step, the solvent or mixture of solvents is preferably pure, in other words it contains only the solvent or mixture of solvents and during the attack on the surface of the article, in particular a polycarbonate article, only the thermoplastic material of the article is dissolved in this solvent or these solvents.

In general, at the end of the attack step according to the invention, the solvent or solvents are evaporated so that at the end of this step, the optical article is recovered in its final state or ready for a subsequent treatment, without it being necessary to implement an additional step of removal of the solvent or solvents.

The method of the present invention is illustrated by the following examples and the annexed figures which respectively represent:

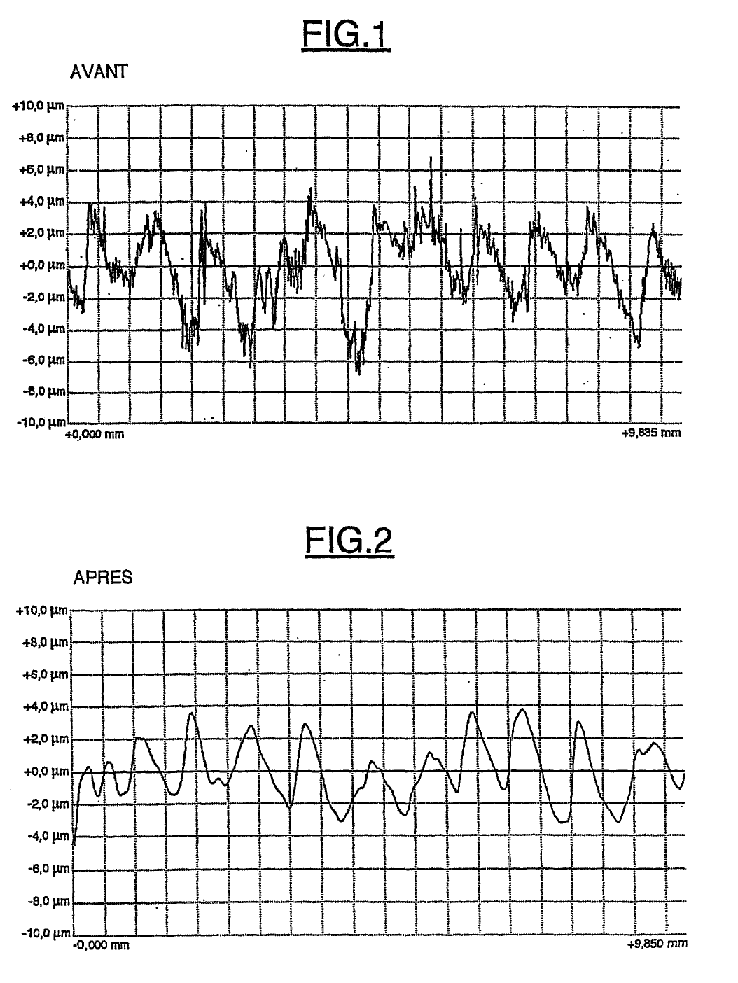

FIG. 1 - a graph representing the profile of waves and roughness of the principal surface of a polycarbonate optical article subjected only to a conventional mechanical grinding;

FIG. 2 - a graph representing the profile of waves and roughness of the principal surface of the optical article of FIG. 1 after an attack step according to the invention by centrifugation with dichloromethane as attack solvent;

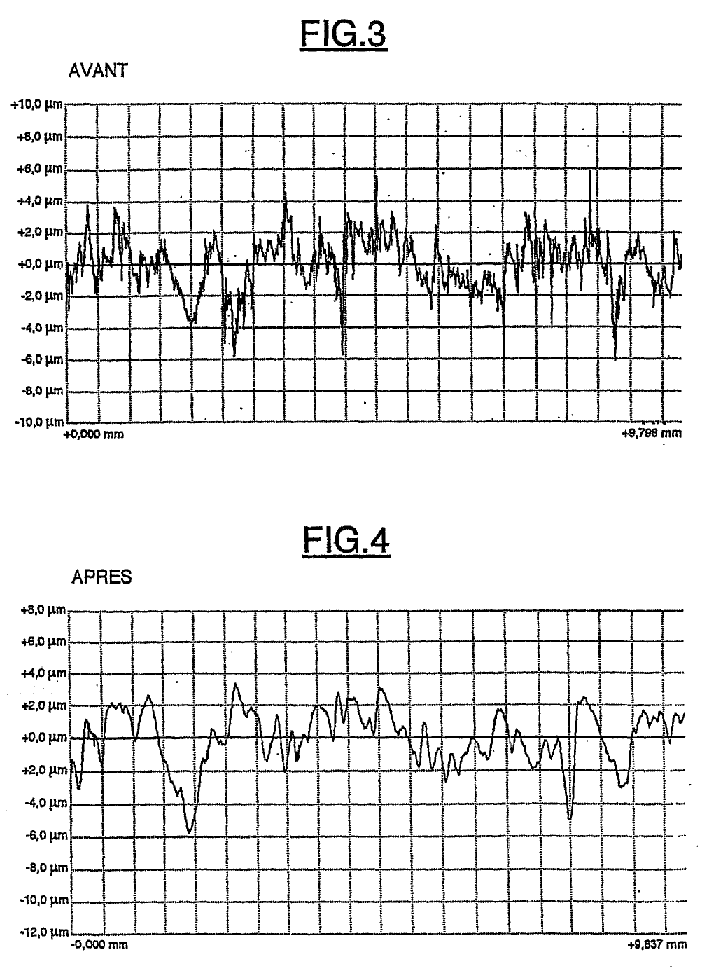

FIG. 3 - a graph representing the profile of waves and roughness of the principal surface of a polycarbonate optical article subjected only to a conventional mechanical grinding;

FIG. 4 - a graph representing the profile of waves and roughness of the principal surface of the optical article of FIG. 3 after an attack step according to the invention by centrifugation with 1,2-dichloromethane as attack solvent;

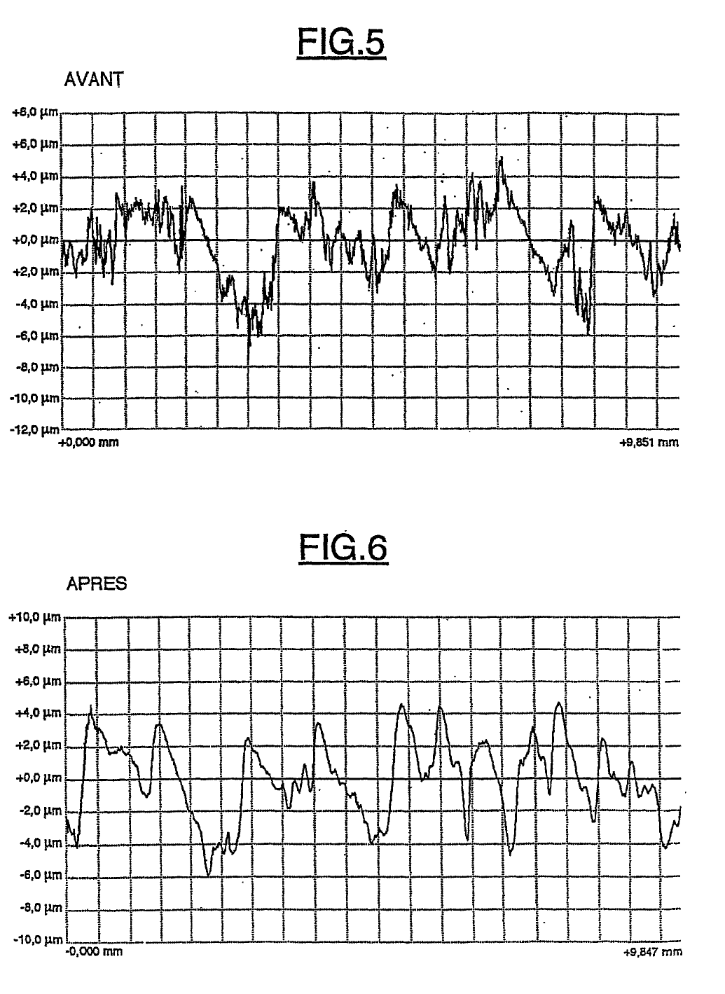

FIG. 5 - a graph representing the profile of waves and roughness of the principal surface of a polycarbonate optical article subjected only to a conventional mechanical grinding;

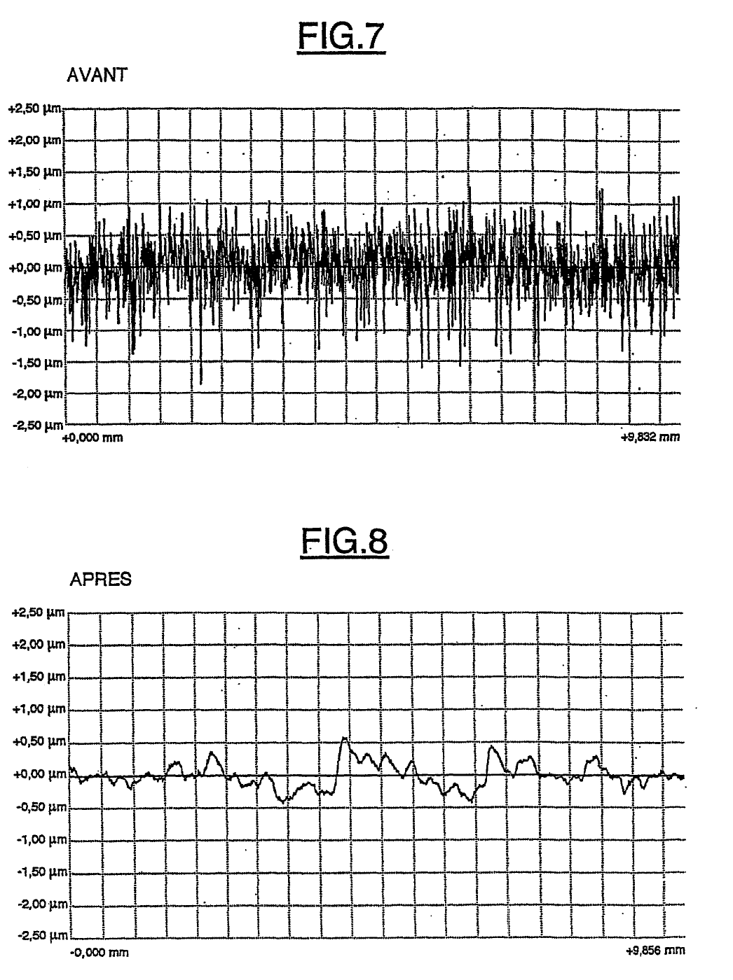

FIG. 6 - a graph representing the profile of waves and roughness of the principal surface of the optical article of FIG. 7 after an attack step according to the invention by centrifugation with THF as attack solvent;

FIG. 7 - a graph representing the profile of waves and roughness of the principal surface of a polycarbonate optical article subjected to conventional grinding and fine grinding steps;

FIG. 8 - a graph representing the profile of waves and roughness of the principal surface of the optical article of FIG. 7 after an attack according to the invention by centrifugation with dichloromethane as solvent;

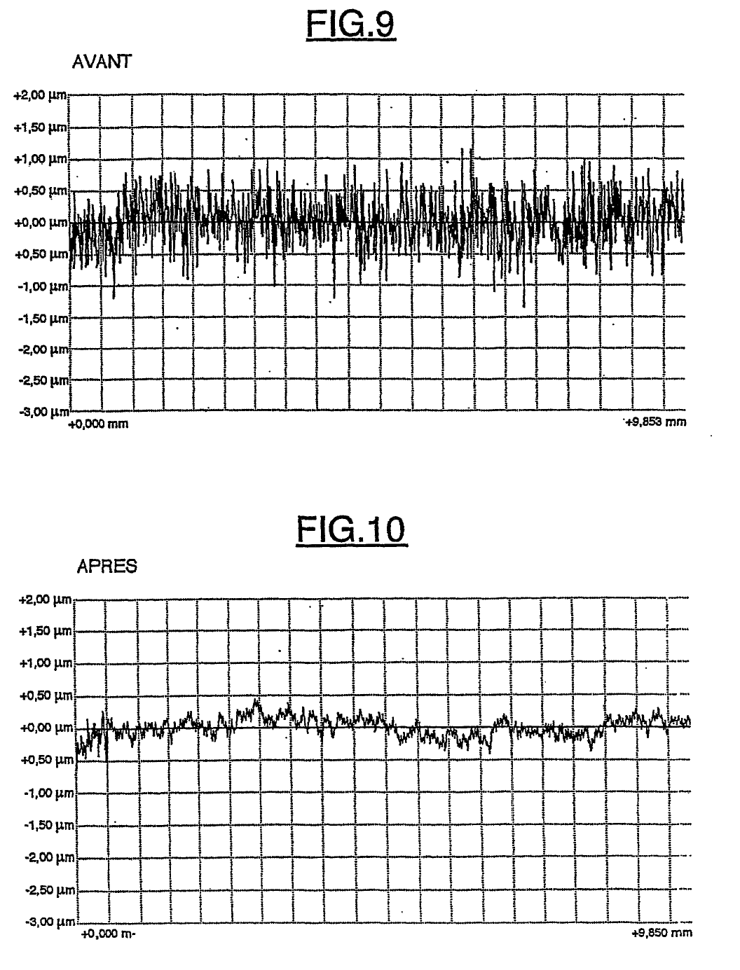

FIG. 9 - a graph representing the profile of waves and roughness of the principal surface of a polycarbonate optical article after conventional mechanical grinding and fine grinding;

FIG. 10 - a graph representing the profile of waves and roughness of the principal surface of the article of FIG. 9 after an attack step according to the invention by centrifugation with 1,2-dichloromethane as attack solvent;

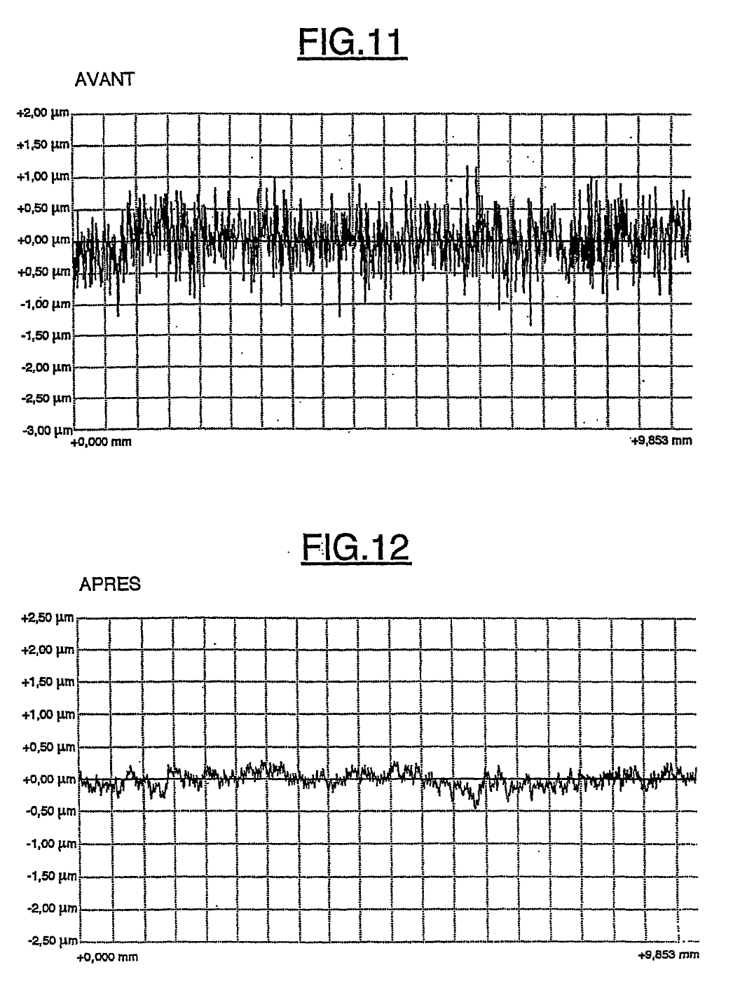

FIG. 11 - a graph representing the profile of waves and roughness of the principal surface of a polycarbonate article after conventional mechanical grinding and fine grinding;

FIG. 12 - a graph representing the profile of waves and roughness of the principal surface of the article of FIG. 11 after an attack step according to the invention by centrifugation with THF as solvent;

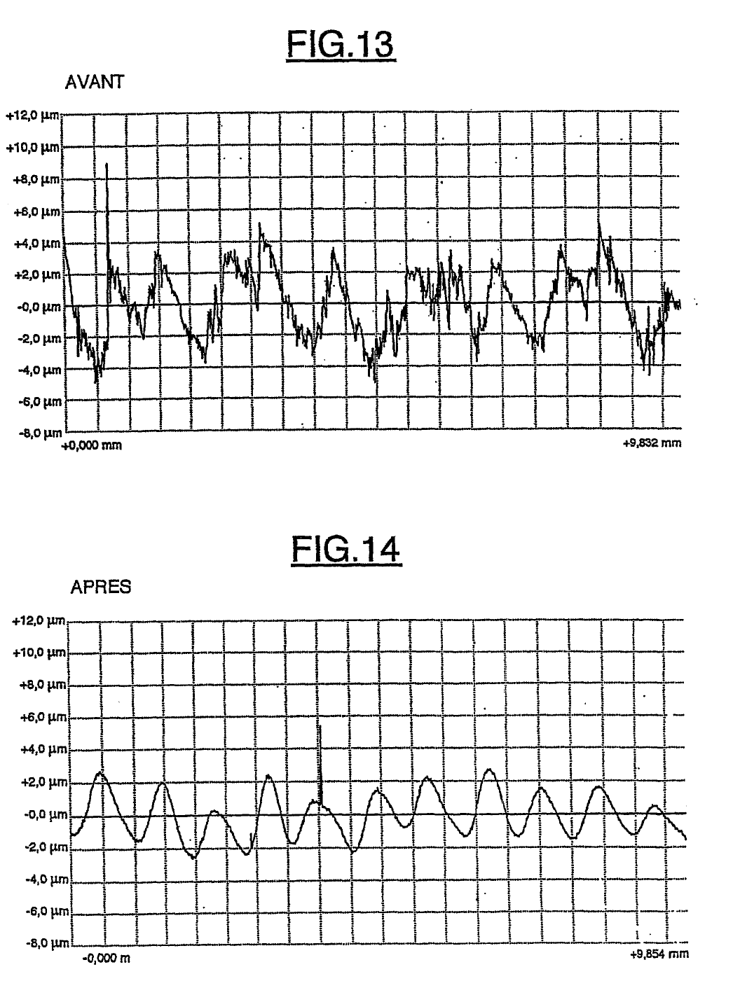

FIG. 13 - a graph representing the profile of waves and roughness of the principal surface of a polycarbonate optical article after a simple conventional mechanical grinding;

FIG. 14 - a graph representing the profile of waves and roughness of the principal surface of the article of FIG. 13 after an attack step in the vapour phase according to the invention for 1 minute 30 seconds with dichloromethane as solvent;

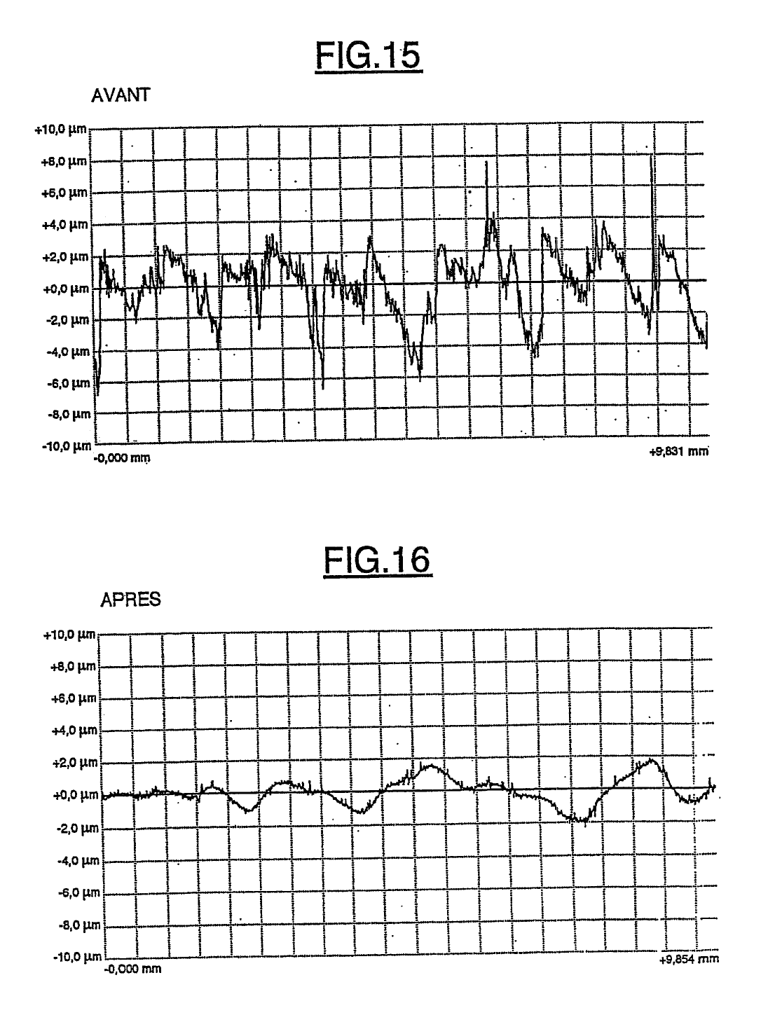

FIG. 15 - a graph representing the profile of waves and roughness of the principal surface of a polycarbonate optical article after a simple conventional mechanical grinding step;

FIG. 16 - a graph representing the profile of waves and roughness of the principal surface of the article of FIG. 15 after an attack step in the vapour phase according to the invention for 5 minutes with dichloromethane as solvent;

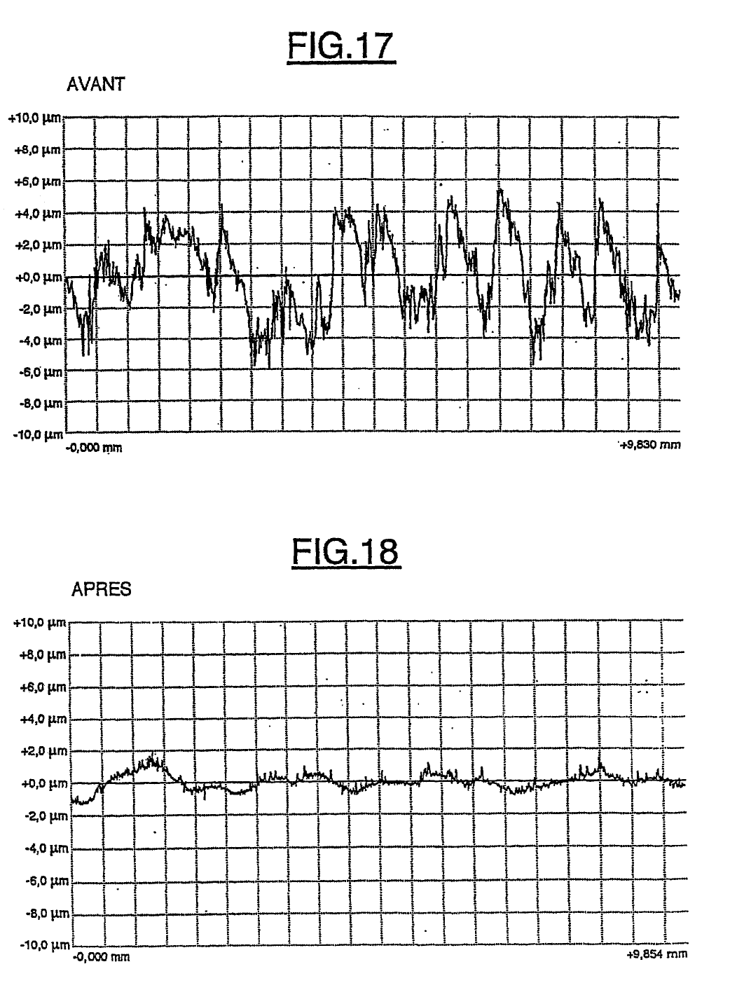

FIG. 17 - a graph representing the profile of waves and roughness of the principal surface of a polycarbonate optical article after a simple conventional mechanical grinding step;

FIG. 18 - a graph representing the profile of waves and roughness of the principal surface of the optical article of FIG. 17 after an attack step in the vapour phase for 10 minutes;

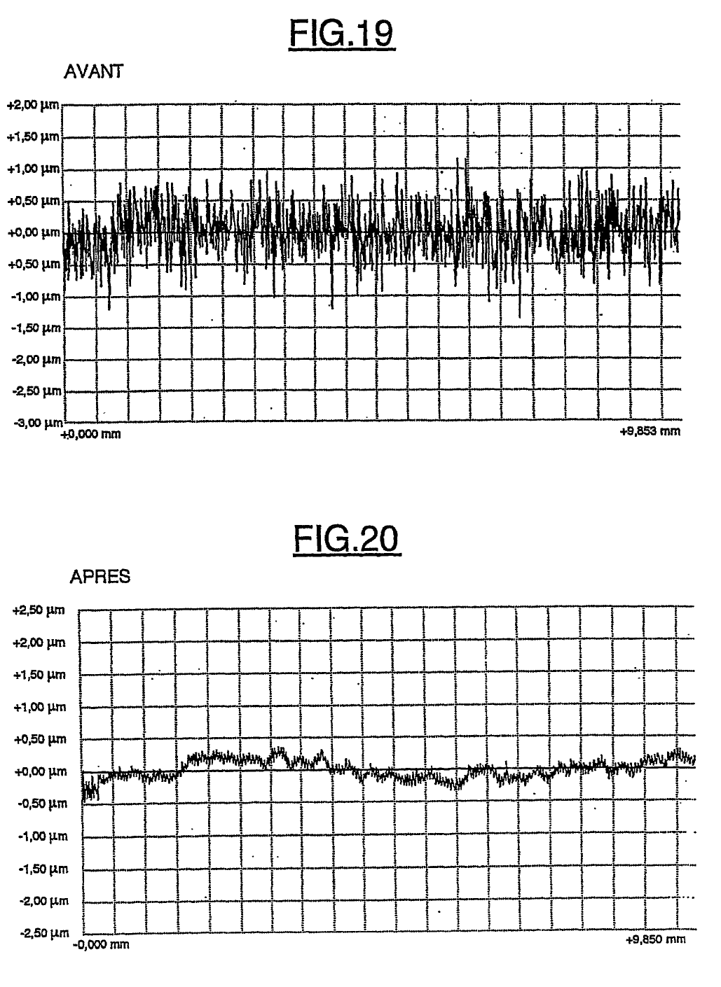

FIG. 19 - a graph representing the profile of waves and roughness of the principal surface of a polycarbonate optical article after conventional mechanical grinding and fine grinding;

FIG. 20 - a graph representing the profile of waves and roughness of the principal surface of the article of FIG. 19 after an attack step in the vapour phase for 1 minute 30 seconds with dichloromethane as solvent;

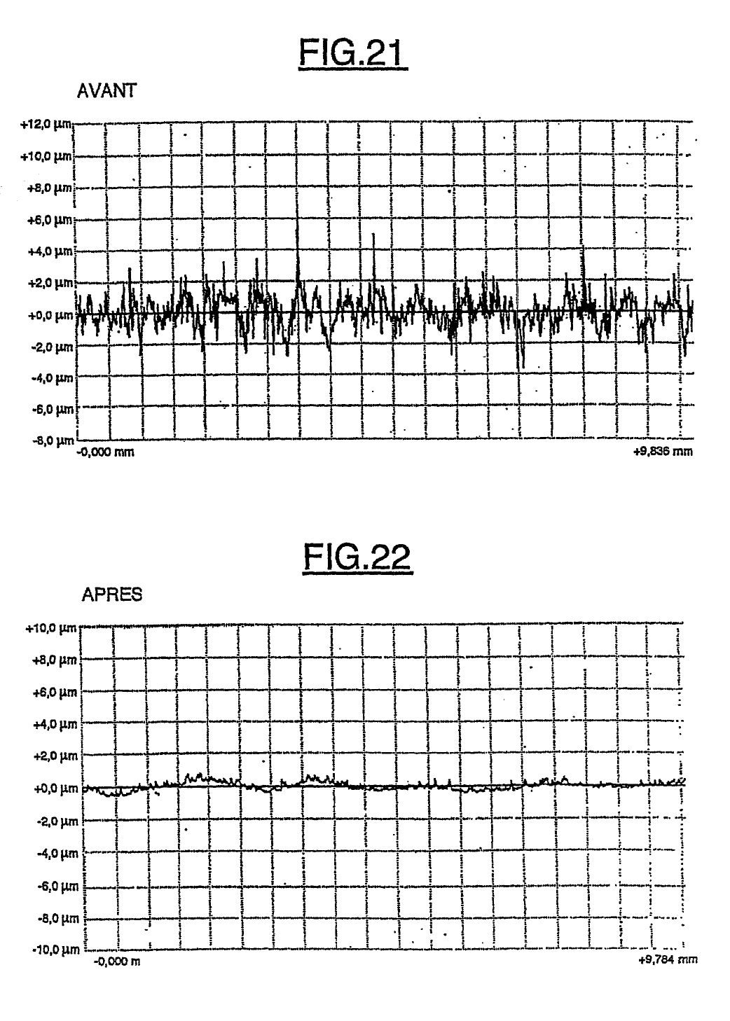

FIG. 21 - a graph representing the profile of waves and roughness of the principal surface of a polycarbonate optical article after conventional grinding;

FIG. 22 - a graph representing the profile of waves and roughness of the principal surface of the article of FIG. 20 after an attack step in the vapour phase for 1 minute 30 seconds with a 50/50 mixture of chloroform and 1,2-dichloromethane with heating followed by an attack step by centrifugation with dichloromethane;

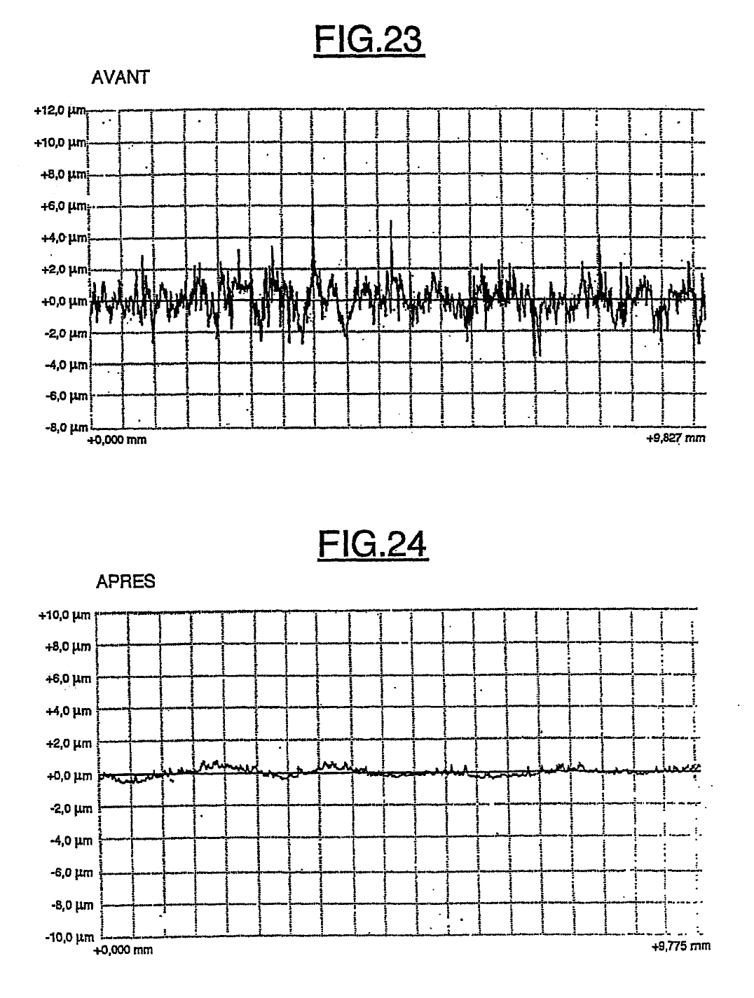

FIG. 23 - a graph representing the profile of waves and roughness of the principal surface of a polycarbonate optical article;

FIG. 24 - a graph representing the profile of waves and roughness of the principal surface of the optical article of FIG. 23 after an attack step in the vapour phase with heating according to the invention with a 50/50 mixture of 1,2-dichloroethane/dichloromethane as solvent.

In the present description and in particular in the following examples, the terms and expressions below have the meanings:

Roughness : defects of low amplitude and high frequency appearing on the surface of the optical article after grinding. These defects are generally characterized by a value Ra, the mean of the deviations of the profile of the defects with respect to the mean line, of from 0.1 to 0.9 μm, typically 0.2 to 0.5 μm.

Waves: Defects of high amplitude and low frequency appearing on the surface of the optical article after grinding, and onto which the roughness is superimposed.

The polycarbonate optical articles used in the examples below were semi-finished polycarbonate discs, marketed by the GENTEX Company, with diameter 80 mm and thickness 10 to 20 mm.

The conventional mechanical grinding of a principal surface of the articles comprised machining the surface of the disc with an insert cutter to remove from 4 to 15 mm of the material of the articles and generate a spherical or toric shape. The grinding took from 20 seconds to 1 minute according to the surface state desired.

The conventional mechanical fine grinding of a principal surface of the articles comprised machining the ground surface of the article using an ORMAREX or LOH polisher with a shaping tool onto which was glued an abrasive silicon carbide polishing pad. The fine grinding time was 2 minutes 30 seconds per article.

The graphs of roughness profile and shape were obtained using an FTS device from the RANK-TAYLOR-HOBSON Company. Profilometry and roughness measurement by laser interferometry.

Principle

The FTS nondestructively measured the geometric properties of a section of the surface of the lenses in the polished or unpolished state.

This surface measurement was performed in a selected plane section.

A two-dimensional profile was thus obtained, represented by the equation Z=f(x).

The FTS was thus mainly used for the revolution lenses.

The shape, wave and roughness characteristics could be extracted from this profile.

The measurements could be used to monitor the surface state at each stage of the lens production (machining, fine grinding, polishing).

Method

The stylus moved on the surface of the article in its profilimetric plane.

The stylus used was a diamond point of radius 2 μm.

It recorded the heights Z of the surface as a functions of its displacement x. This gave the graph Z=f(x).

The profile was compared to an ideal sphere, in other words a sphere for which the deviations of the profile compared to this sphere were minimum.

The characteristics of the deviations of shape compared to the geometric elements could be extracted from this graph.

The characteristics of the profile in terms of waves and roughness could also be obtained.

All the results were calculated by computer, the parameters and filters being in accordance with international standards, including the characteristics of the Gaussian filter and the choice of bandwidth used to evaluate the data.

Some definitions

Filter : it deletes the components of long wavelength from the signal of the profile. Such a filter is called “low-pass”.

Comments on the graphs

Roughness graphs:

The measurement was made over 10 mm with a roughness sensor (diamond point with radius 2 μm) and began 10 mm from the centre.

The results given (e.g. Ra=0.02 μm) correspond to a roughness measurement performed with a Gaussian filter and a cut-off length of 0.08 μm. This filtered out the wave defect, thus leaving only the roughness defect. The graph corresponding to this measurement should be a straight line, since the surface waves are filtered out.

The graphs attached to the present description correspond to a reprocessing of the preceding measurement except that no filter was used. It is thus possible to display the roughness and wave defects.

Centrifugation attack

The surface to be treated of each article was measured before treatment for roughness and in some cases shape.

The surface of the article to be treated was first cleaned with isopropanol (manual rubbing) to remove residual dust from the surface.

The article was then placed on the axis of the centrifugation device where it was maintained by suction.

Once the article had reached a rotation speed of 4000 r.p.m., the solvent was dynamically deposited on the surface of the article in a rapid movement from the centre towards the edge (C to E), so as to cover the whole of the surface. This deposition of solvent took about 1 second. This dynamic deposition (radial deposition) gave a homogeneous distribution of the solvent over the surface of the article.

After the solvent had been deposited, the article was rotated at a speed of 4000 r.p.m. for about 9 seconds, i.e. a total attack time of about 10 seconds. During the final 9 seconds, the excess solvent on the surface was ejected. The solvent which had penetrated into the polycarbonate network evaporated.

The rotation was then stopped (about 3 seconds required to bring to a complete halt) and the article was recovered.

At this stage, the treated surface of the article was dry and the article could be handled.

The surface of the article was then examined visually, by reflection under fluorescent light against a black background, or under an arc lamp.

The roughness of the surface and its shape were measured using the same apparatus.

Attack by saturated solvent vapour

The surface to be treated of each article was measured before treatment for roughness and shape.

The equipment used comprised a glass vessel, hermetic to air. This vessel was composed of two parts: a recipient and a cover maintained by silicone grease.

Half-way up the vessel recipient was a metal grille resting on the walls of the recipient. This grille was pierced by uniformly distributed small holes.

The solvent was placed in the recipient under the grille. The height of the solvent was about 5 cm. The solvent was stirred magnetically to give even distribution of the vapour. After about 10 minutes, the vessel was saturated with vapour.

Once the vessel was saturated in solvent vapour, the article was placed on the grille with the surface to be treated facing downwards (convex surface towards the top of the vessel, concave surface towards the bottom in the case of a lens whose back surface was to be treated).

The vessel was closed. The solvent was gently stirred to avoid any direct splashing onto the article. The article/vapour contact time was measured from the time that the vessel was closed. The contact time could be varied according to the final surface state desired.

Once the contact time was complete, the vessel was opened and the article withdrawn. The article was left in air for a few minutes so that the remaining solvent could evaporate slowly. The article could then be handled.

The treated surfaces of the articles were then measured for roughness and shape.

Attack with hot solvent vapour

The surface to be treated of each article was measured before treatment for roughness and shape. The measurement instrument used was a shape sensor which could be displaced on the surface. The graph after analysis gave a topographical evaluation of the initial surface.

All the articles were placed in an oven at 60° C. (for about 15 minutes) before treatment with the vapour. This avoided too great a condensation of the vapours on the surface when the article was placed in the vessel.

The equipment used comprised a glass vessel, hermetic to air.

This vessel was composed of two parts: a recipient and a cover maintained by silicone grease.

Half-way up the vessel recipient was a metal grille resting on the walls of the recipient.

This grille was pierced by uniformly distributed small holes.

The solvent was placed in the recipient under the grille. The height of the solvent was about 5 cm.

The solvent was stirred magnetically and heated to reflux using a thermal gun. The heating was stopped once the reflux was established.

The vessel was then ready to receive the sample

Once the solvent reflux was well established, the article to be polished was placed on the grille. It was noted that the polishing process was more even when the article was placed with the convex surface facing downwards, concave surface facing upwards. The surface to be polished was thus not directly in contact with the rising vapours.

This arrangement was more practical for handling the sample and led to less deformation of the surface to be polished.

The vessel was closed. The solvent was gently stirred to avoid any direct splashing onto the article.

The article/vapour contact time was measured from the time that the vessel was closed. This contact time could be varied according to the final surface state desired.

(When the vapours were hot, the surface polishing process was accelerated. The contact times were thus shorter than when the article was treated with cold vapour).

The contact time with the hot solvent was thus from 30 seconds to 90 seconds for a ground surface and from 10 seconds to 60 seconds for a fine ground surface.

When the contact time was complete, the vessel was opened and the article withdrawn. This was placed in air for a few minutes on a mat so that the solvent which had penetrated into the network could evaporate slowly. The article could then be handled.

The surface of the article after treatment could be observed by reflection under fluorescent light against a black background.

In the case of transparent surfaces, the articles could be observed under an arc lamp.

Each treated article was measured for roughness and shape using the same instrument as before the treatment.

The effect of the vapours and the contact time could be characterized by a comparative analysis of the FTS graphs before and after treatment.

The hot vapours condensed on the surface immediately the article was placed in the vessel. A solvent film was formed directly in contact with the surface to be polished.

This method, as above for the cold vapours, reduced the amplitude of the waves, but also simultaneously gave a major reduction in roughness (0.01 μm<Ra<0.03 μm).

The surfaces obtained were thus transparent.

### EXAMPLES

Conventionally ground, or ground and fine ground surfaces of polycarbonate lenses were subjected to attacks according to the invention, under conditions detailed in the table below.

The Ra values were measured and roughness graphs were established for the lens surfaces before and after chemical attack. The results are given in the table below.

TABLE

| | | | | Attack | | | | |
|---|---|---|---|---|---|---|---|---|
| | Initial state of | | | Saturated | Hot | | | |
| | surface treated | | | vapour | vapour | | Ra | |
| | | Fine | Centrif- | (attack | (attack | | Before | After |
| Example | Ground | ground | ugation | time in s) | time in s) | Solvent | attack | attack |
| 1 | X | — | C to E | — | — | CH₂Cl₂ | 0.32 | 0.02 |
| 2 | X | — | C to E | — | — | ClCH₂CH₂Cl | 0.35 | 0.06 |
| 3 | X | — | C to E | — | — | THF | 0.27 | 0.06 |
| 4 | X | X | C to E | — | — | CH₂Cl₂ | 0.31 | 0.01 |
| 5 | X | X | C to E | — | — | ClCH₂CH₂Cl | 0.24 | 0.05 |
| 6 | X | X | C to E | — | — | THF | 0.24 | 0.05 |
| 7 | X | X | — | 1.5 | — | CH₂Cl₂ | 0.29 | 0.05 |
| 8 | X | X | — | 5 | — | CH₂Cl₂ | 0.3 | 0.07 |
| 9 | X | X | — | 10 | — | CH₂Cl₂ | 0.36 | 0.09 |
| 10 | X | X | X | 1.5 | — | CH₂Cl₂ | 0.22 | 0.05 |
| 11 | X | — | X | — | 90 | CHCl₃/CH₂Cl₂ | 0.39 | 0.04 |
| | | | | | | (50/50) | | |
| 12 | X | — | — | — | 60 | ClCH₂CH₂Cl/ | 0.47 | 0.02 |
| | | | | | | CH₂Cl₂ | | |
| | | | | | | (50/50 | | |

FIGS. 1 to 12 are graphs representing the roughness of the surfaces of the articles of examples 1 to 6 before and after attack by centrifugation with different solvents.

These graphs show a significant reduction in roughness both for the surfaces which are ground only and for the ground and fine ground surfaces.

FIGS. 13 to 20 are graphs representing the roughness profile of the surfaces of the articles of the lenses of the examples 7 to 10 before and after attack according to the invention. These graphs show a significant reduction in roughness after the attack both for the surfaces which are ground only and for the ground and fine ground surfaces. However, FIGS. 14, 16 and 18 show that increasing the attack time by the vapour to 5 minutes and more led to a slight increase of the roughness.

FIGS. 21 and 22 are graphs representing the roughness profile of the lenses of example 11 before and after attack first by centrifugation, then by hot vapour.

FIGS. 23 and 24 are graphs representing the roughness profile of the lenses of example 12 before and after attack by hot vapour.

[image]

[image]

[image]

[image]

[image]

[image]

[image]

1. Method of surface polishing of at least one principal surface of an optical article made from transparent thermoplastic material comprising a grinding step, a fine grinding step and a polishing step, characterized in that the fine grinding and/or polishing step consists of an attack on the principal surface of the article by a solvent or a mixture of organic solvents of the transparent thermoplastic material.

2. Method characterized in that the attack constitutes the polishing step.

3. Method according to claim 1 or 2, characterized in that the attack is performed by centrifugation of the solvent or mixture of solvents on the principal surface of the article.

4. Method according to claim 3, characterized in that the solvent or mixture of solvents is deposited on the principal surface following a radial deposition.

5. Method according to claim 4, characterized in that the radial deposition takes place from the centre to the edge of the article.

6. Method according to claim 1 or 2, characterized in that the attack is performed by placing the principal surface in contact with the vapour of a solvent or mixture of solvents.

7. Method according to claim 6, characterized in that the vapour is produced by heating the solvent or mixture of solvents.

8. Method according to claim 7, characterized in that the solvent or mixture of solvents is heated to its boiling point.

9. Method according to claim 6, characterized in that the contact of the principal surface with the vapour of the solvent or mixture of solvents is performed by saturation with the vapour of the solvent or mixture of solvents.

10. Method according to claim 9, characterized in that the solvent vapour is at ambient temperature.

11. Method according to claim 1 or 2, characterized in that the attack step comprises an attack by centrifugation and an attack in the vapour phase.

12. Method according to claim 11, characterised in that the attack by centrifugation precedes the attack in the vapour phase.

13. Method according to claim 11, characterized in that the attack by centrifugation follows the attack in the vapour phase.

14. Method according to claim 8, characterized in that the optical article is heated to a temperature lower than the boiling point of the solvent or mixture of solvents.

15. Method according to any of the preceding claims. characterized in that the solvent is selected from dichloromethane, the dichloroethanes, acetone, methyl ethyl ketone, trichloromethane, THF and dioxane.

16. Method according to any of the preceding claims. characterized in that the transparent thermoplastic material is polycarbonate.

17. Method according to any of the preceding claims. characterized in that the optical article is a spectacle lens.
